(19) United States
(12) Patent Application Publication
(10) Pub. No.: US 2025/0094193 A1
(43) Pub. Date: Mar. 20, 2025

(54) MIGRATION DESTINATION DETERMINATION APPARATUS, PHYSICAL SERVER, MIGRATION DESTINATION DETERMINATION SYSTEM, MIGRATION DESTINATION DETERMINATION METHOD AND PROGRAM

(71) Applicant: NIPPON TELEGRAPH AND TELEPHONE CORPORATION, Tokyo (JP)

(72) Inventor: Shigeaki HARADA, Tokyo (JP)

(21) Appl. No.: 18/291,727

(22) PCT Filed: Aug. 16, 2021
(86) PCT No.: PCT/JP2021/029924

§ 371 Date: Jan. 24, 2024

(51) Int. Cl. G06F 9/455

(52) U.S. Cl. CPC G06F 9/45558; G06F 2009/4557

(57) ABSTRACT

A migration destination determination apparatus configured to, in migration of a virtual machine, determine a physical server as a migration destination of the virtual machine, the migration destination determination apparatus including: an extraction unit configured to extract one or more variation patterns in resource usage from resource amount logs acquired from a plurality of physical servers; and a migration destination determination unit configured to determine, based on a similarity between a variation pattern in resource usage of the virtual machine in an area of a migration source and a variation pattern in resource usage of a physical server in another area, the physical server as a migration destination of the virtual machine.

### TECHNICAL FIELD

The present invention relates to migration in which a virtual machine is moved from a physical server to another physical server.

### BACKGROUND ART

In order to maintain network services, information and communication technology (ICT) services, and other services, service providers such as communication carriers and data center operators continuously monitor the status of services and perform setting or control on communication facilities and server instruments.

In normal times, facilities are operated on the basis of the power supply conditions contracted for each building, but in the event of power outages due to disasters, and the like, it is necessary to maintain services within the power supply range of a generator installed in each building. Since the power that can be supplied from a generator (output/single maintenance time) is smaller than that of power sources in normal times, it is necessary to take measures such as narrowing down services to be maintained in preparation for a case where the power outage continues for a long period of time.

In the past, physical resources such as communication facilities and server instruments installed in each building and the services provided thereon have been closely linked to each other. However, recent advances in virtualization technology have enabled various services to be provided on virtual machines, which makes it possible to handle physical resources (physical servers) and services (virtual machines) independently. This makes it easier to migrate a virtual machine from a certain physical resource to another physical resource, or consolidate virtual machines distributed across a plurality of physical resources into a single physical resource. By utilizing this virtualization technology, in addition to narrowing down services to be maintained during long-term power outages, it is possible to take measures to move services to buildings where power outages have not occurred.

### CITATION LIST

### Non Patent Literature

NPL 1: Lessons Learnt from a Preliminary Prototype of a Best-Effort Pre-synchronization Mechanism for Wide-Area Live Migration of Virtual Machines, Research Report Computer Architecture (ARC), 2012
NPL 2: Virtual Machine Migration Mechanism across Heterogeneous Clusters, IPSJ SIG Technical Report, Vol. 2013-OS-126 No. 15
NPL 3: Proposal of Highly Efficient Operation Method for Data Center Using Migration and Performance Evaluation of VM in Over-Commitment, Transactions of Information Processing Society of Japan, 2018

### SUMMARY OF INVENTION

### Technical Problem

When services are migrated between buildings, it is not always possible to perform a one-to-one migration from a physical server in a migration source building to a physical server in a migration destination building because there are also services that are running in the migration destination building. Therefore, it is necessary to determine a migration destination in units of virtual machines. FIG. 1 shows an example in which a plurality of virtual machines housed in a physical server A-1 in a building A, which is a migration source, are migrated onto two physical servers B-1 and B-2 in a building B, which is a migration destination.

In addition, in order to prevent resource depletion at the migration destination due to migration of the virtual machine, it is necessary to confirm that the allowable upper limit of physical resources of migration destinations is not exceeded in a case where the amount of resources (such as power/virtual CPU/virtual memory size/virtual storage capacity/line bandwidth) required by the virtual machine housed in the migration source is superimposed on the amount of resources consumed by the virtual machine housed in the migration destination. In addition, since the amount of resources required by the virtual machine fluctuates depending on service demand, it is also important to confirm that the allowable upper limit of the amount of resources will not be exceeded until migration source power is restored. However, if it is necessary to migrate between a plurality of buildings in the event of a large-scale power outage, and the like, the number of combinations of migration sources and migration destinations will be enormous, making confirmation thereof difficult. FIG. 2 shows an example of migration between a plurality of buildings in a power outage area and a plurality of buildings in a migration destination area 1 and a migration destination area 2.

NPL 1 discloses a technique for remote live migration in the event of a disaster, but it only points out problems with data transfer associated with migration and does not address resource conflicts in the physical servers of a migration destination.

NPL 2 discloses a technique for migration between clouds with heterogeneous environments, but it is a study focusing on the virtualization overhead of I/O devices and does not mention avoidance of conflict including other resources.

NPL 3 points out that excessive over-commitment has an adverse effect on performance with respect to over-commitment for allocating a number of virtual machines exceeding the resource upper limit of the physical server, but it is limited to performance analysis for virtual CPUs and does not address other resource conflicts.

The present invention has been made in view of the above points, and an object thereof is to provide a technique that makes it possible to determine a migration destination so that resource depletion does not occur on a physical server of a migration destination in migration where a virtual machine is moved from a certain physical server to another physical server.

### Solution to Problem

According to the disclosed technique, there is provided a migration destination determination apparatus configured to, in migration of a virtual machine, determine a physical server as a migration destination of the virtual machine, the migration destination determination apparatus including:
an extraction unit configured to extract one or more variation patterns in resource usage from resource amount logs acquired from a plurality of physical servers; and
a migration destination determination unit configured to determine, based on a similarity between a variation pattern in resource usage of the virtual machine in an area of a migration source and a variation pattern in resource usage of a physical server in another area, the physical server as a migration destination of the virtual machine.

### Advantageous Effects of Invention

According to the disclosed technique, it is possible to provide a technique that makes it possible to determine a migration destination so that resource depletion does not occur on a physical server of a migration destination in migration where a virtual machine is moved from a certain physical server to another physical server.

### BRIEF DESCRIPTION OF DRAWINGS

FIG. 1 is a diagram illustrating determination of a migration destination in units of virtual machines.

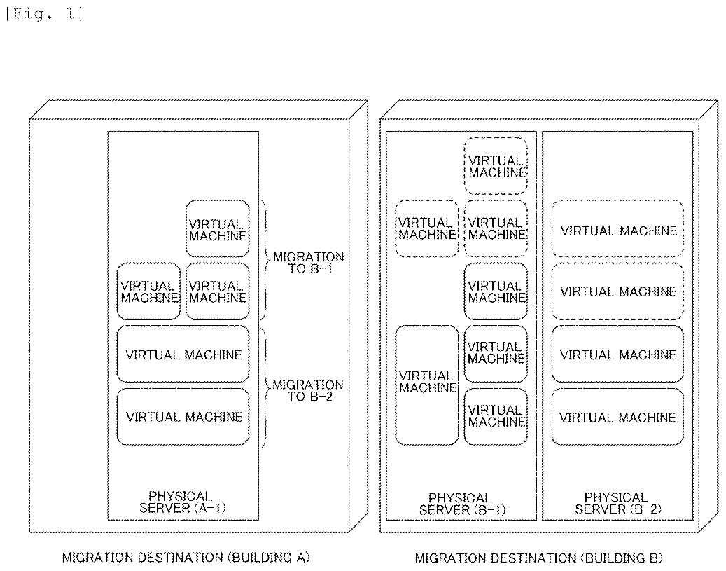

FIG. 2 is a diagram illustrating an example of a case where there is a plurality of areas of migration destination candidates for a power outage area.

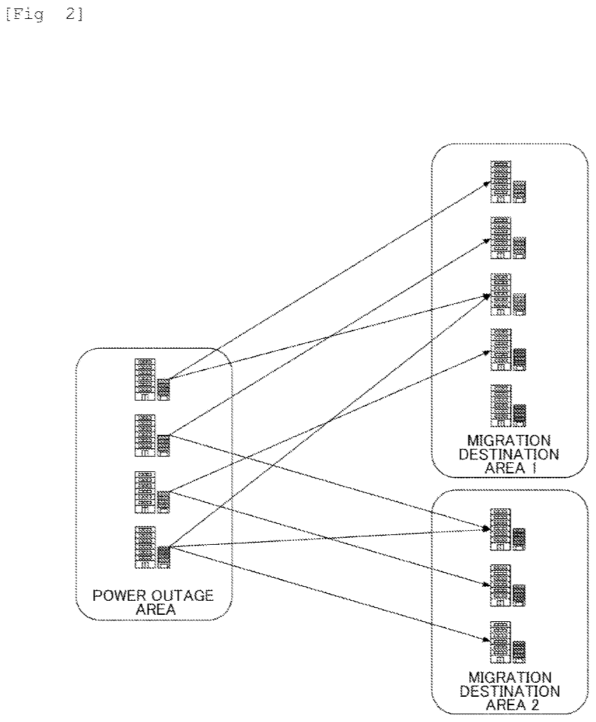

FIG. 3 is a diagram illustrating a system configuration example in an embodiment of the present invention.

FIG. 4 is a diagram illustrating a connection configuration example of an ICT instrument monitoring device.

FIG. 5 is a diagram illustrating a connection configuration example of the ICT instrument monitoring device.

FIG. 6 is a functional configuration diagram of a physical server.

FIG. 7 is a diagram illustrating examples of a resource amount log.

FIG. 8 is a flowchart illustrating an operation example of an ICT resource migration destination determination apparatus.

FIG. 9 is a diagram illustrating a nearby area.

FIG. 10 is a diagram illustrating an example of a three-dimensional array.

FIG. 11 is a diagram illustrating an example of a two-dimensional array.

FIG. 12 is a diagram illustrating an example of a partial array.

FIG. 13 is a diagram illustrating a hardware configuration example of a device.

### DESCRIPTION OF EMBODIMENTS

Hereinafter, an embodiment (present embodiment) of the present invention will be described with reference to the accompanying drawings. An embodiment to be described below is an example, and an embodiment to which the present disclosure is applied is not limited to the following embodiment.

### Outline of Embodiment

In the present embodiment, focusing on the similarity between a virtual machine and a physical server for variation patterns in resource usage based on collected information on power consumption, device load, and traffic volume, an ICT resource migration destination determination apparatus 100 to be described later determines a physical server as a migration destination of the virtual machine based on the similarity.

In order to avoid resource depletion when migrating from another physical server to a physical server where a service is running, it is necessary to cause virtual machines requiring resources different from the services on the physical server of a migration destination to coexist on the physical server, or cause virtual machines requiring the same resource but having different usage time slots to coexist on the physical server. Requiring different resources, requiring the same resource but having different usage time slots, and the like are examples of low similarity of variation patterns in resource usage.

By ascertaining the similarity of variation patterns in resource usage between different buildings and servers using a technique to be described below in detail, the ICT resource migration destination determination apparatus 100 can quickly discover a migration destination having a variation pattern with low similarity to the variation pattern in resource usage of the virtual machine of a migration source, and can realize migration with reduced resource conflict.

### (System Configuration Example)

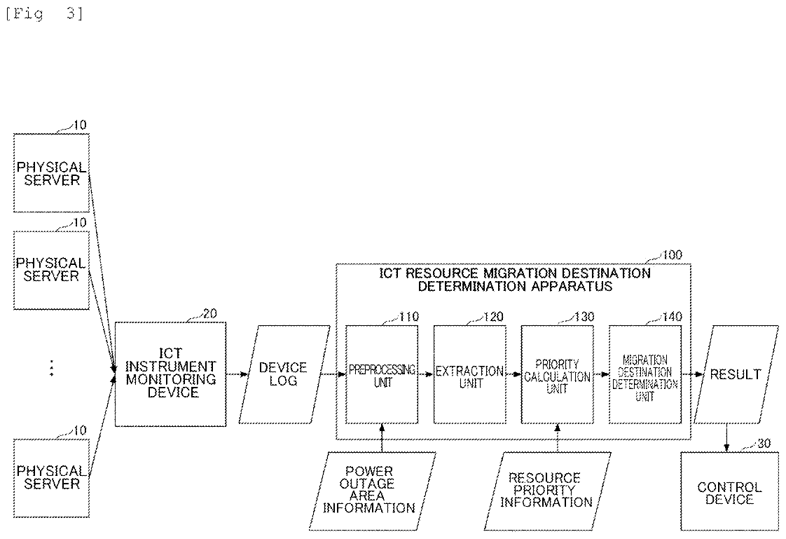

FIG. 3 is a diagram illustrating a functional configuration of the ICT resource migration destination determination apparatus 100 in the embodiment of the present invention. In addition, FIG. 3 also shows a plurality of physical servers 10, an ICT instrument monitoring device 20, and a control device 30. Meanwhile, the ICT resource migration destination determination apparatus 100 may be referred to as a “migration destination determination apparatus.” In addition, a system including the ICT resource migration destination determination apparatus 100 and the ICT instrument monitoring device 20 may be referred to as a migration destination determination system.

In the example of FIG. 3, the plurality of physical servers 10 are distributed and housed in a plurality of buildings. The ICT instrument monitoring device 20 is connected to the plurality of physical servers 10 through a network and collects device logs from the plurality of physical servers 10. The ICT resource migration destination determination apparatus 100 is connected to the ICT instrument monitoring device 20 through a network and acquires device logs from the ICT instrument monitoring device 20.

The control device 30 receives information (such as an address) on the migration destination of the virtual machine, which is a processing result from the ICT instrument monitoring device 20, and instructs the corresponding physical servers (for example, the physical server of a migration source and the physical server of a migration destination) on the basis of the information to execute the migration of the virtual machine from the physical server of a migration source to the physical server of a migration destination. Meanwhile, the ICT resource migration destination determination apparatus 100 may include the functions of the control device 30.

As shown in FIG. 3, the ICT resource migration destination determination apparatus 100 includes a preprocessing unit 110, an extraction unit 120, a priority calculation unit 130, and a migration destination determination unit 140. Meanwhile, the functions of the preprocessing unit 110 may be included in the extraction unit 120. In addition, the functions of the priority calculation unit 130 may be included in the migration destination determination unit 140. The function outline of each unit is as follows.

The preprocessing unit 110 reads out the resource amount log from the ICT instrument monitoring device 20, and narrows down and processes data to be analyzed. The extraction unit 120 analyzes the processed data as an input, extracts any predetermined number of representative variation patterns from the input data, and calculates “the degree of association” indicating a degree to which the items of the respective axes of the input data are associated with each pattern.

The priority calculation unit 130 calculates a weight for determining the order of evaluating the migration destination of the virtual machines on the basis of the priority of each resource separately designated by the person performing the analysis.

The migration destination determination unit 140 determines the order of evaluating the migration destinations of the virtual machines using a weight in the priority calculation unit 130 in the previous stage, evaluates the migration destinations of the virtual machines in the power outage area in accordance with the evaluation order, determines the migration destinations, and outputs the result. Meanwhile, in the present embodiment, it is assumed that a virtual machine on a physical server in a building located in a power outage area is moved, but this is just an example and the reason for migration is arbitrary. For example, a virtual machine may be moved to a physical server in another building in advance for building construction.

In addition, the unit of “area” in the present embodiment is arbitrary. The “area” may be a unit such as a municipality or a grid unit of a predetermined, or one building may be one area.

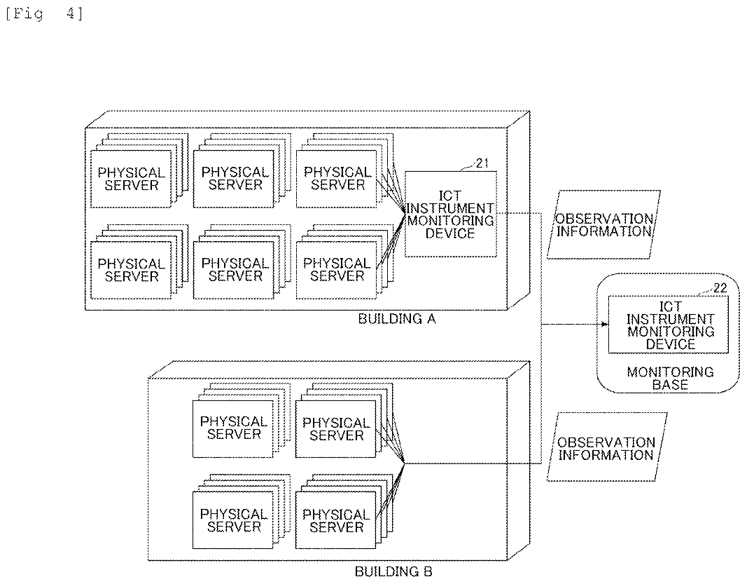

FIG. 4 shows an example of a more detailed connection configuration regarding the ICT instrument monitoring device and the physical server. In the example shown in FIG. 4, a building A is equipped with an ICT instrument monitoring device 21, and a monitoring base is equipped with an ICT instrument monitoring device 22.

The ICT instrument monitoring devices 21 and 22 collect and accumulate device logs of the physical server as observation information. An instrument such as a sensor capable of transmitting observation information may be added to observe the state of the physical server. It is assumed that device logs of ICT instruments including these physical servers are periodically transmitted to the ICT instrument monitoring devices 21 and 22, but the ICT instrument monitoring devices 21 and 22 may actively acquire the device logs of the ICT instruments from the physical servers.

The ICT instrument monitoring device may be installed in each building, may be installed in an external monitoring base, or may be configured in multiple stages. The example of FIG. 4 is an example in which ICT instrument monitoring devices are configured in multiple stages in the building A and the monitoring base.

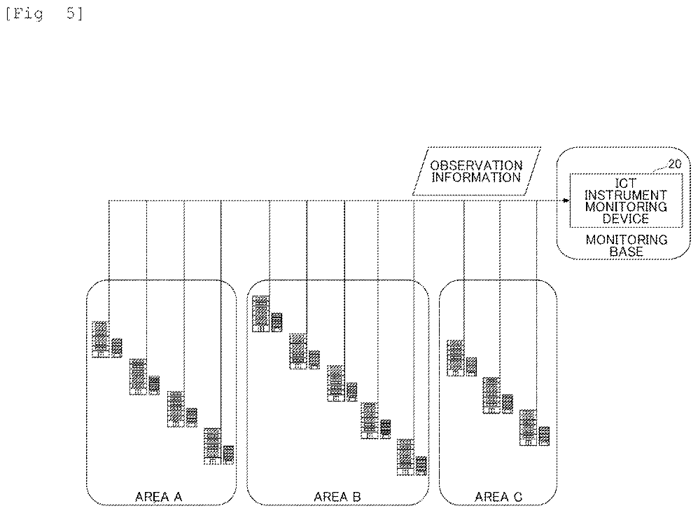

As shown in FIG. 5, the ICT instrument monitoring device 20 may monitor a plurality of areas. In addition, the device log of the ICT instrument is assumed to be recorded in the main memory or the secondary storage device (collectively referred to as storage means) of the ICT instrument monitoring device 20, but there is no limitation thereto.

In the following description, the ICT instrument on which the virtual machine operates is assumed to be a physical server. Meanwhile, the ICT instrument including a physical server may be referred to as an information communication device.

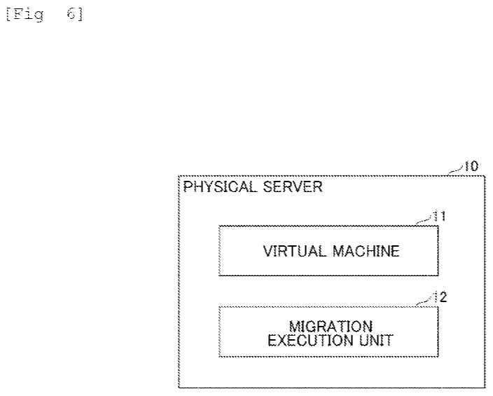

FIG. 6 shows a functional configuration example of a physical server 10. As shown in FIG. 6, the physical server 10 includes a virtual machine 11 and a migration execution unit 12. The migration execution unit 12 receives information on the migration destination of the virtual machine 11 determined by the ICT resource migration destination determination apparatus 100, for example, from the control device 30, and executes migration in which the virtual machine 11 is moved to the physical server of a migration destination on the basis of the information. In migration, for example, a memory image of the virtual machine 11 is transferred to the physical server of a migration destination.

### (Example of Device Log)

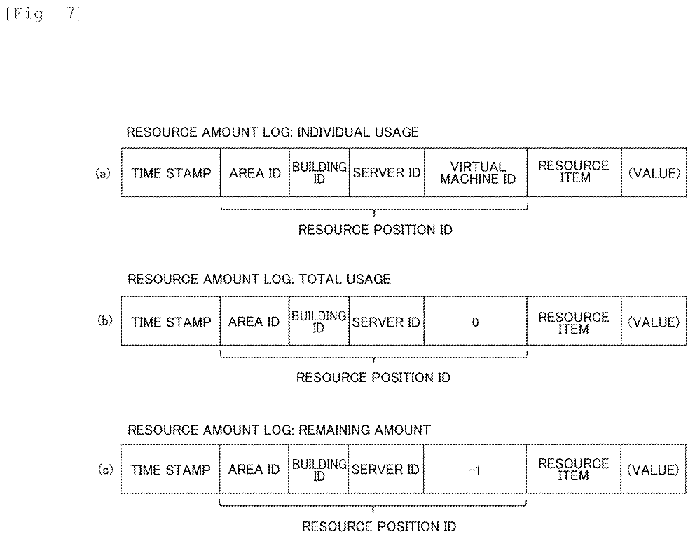

In the present embodiment, the ICT instrument monitoring device 20 records a resource amount log indicating individual usage, a resource amount log indicating total usage, and a resource amount log indicating the remaining amount in the storage means in the formats shown in FIGS. 7(a), (b), and (c) from the device logs of the physical server collected from the physical server.

The time stamp in the resource amount log of individual usage shown in FIG. 7(a) is the time when the resource amount log was saved. The area ID, the building ID, and the server ID are identifiers arbitrarily assigned by the communication carrier. The area ID is an ID of an area of a log acquisition source, the building ID is an ID of a building of the log acquisition source, and the server ID is an ID of a physical server of the log acquisition source.

The virtual machine ID is an ID of a virtual machine of the log acquisition source, and may be arbitrarily assigned by the communication carrier or automatically assigned by the virtualization system. Specific examples of resource items include power, a virtual CPU, virtual memory size, virtual storage capacity, and line bandwidth. The resource value is a value associated with each resource item and represents the amount of resource consumption for each virtual machine, such as the amount of power used by the virtual machine in the case of the power and the amount of logical CPU allocation to the virtual machine in the case of the virtual CPU.

The resource amount log of total usage shown in FIG. 7(b) is a log of total resource usage in the physical server indicated by the resource position ID to be described later. The value of the log may be directly collected from each server, or may be calculated from logs having a common area ID, building ID, and server ID in the resource amount logs of individual usage.

The resource amount log of the remaining amount shown in FIG. 7(c) is a log of the remaining amount of resources in the physical server indicated by the resource position ID. For the value of the log, the observed resource values may be used for those capable of being observed. The value may be calculated by the difference between the upper limit amount for each resource item given separately and the resource value of total usage, or may be calculated, even in a case where the resource upper limit amount is not given, by the difference between the maximum resource value in the past, which is regarded as the resource upper limit amount, and the resource value of total usage.

Meanwhile, the resource amount log of total usage and the resource amount log of the remaining amount are stored in the same format as the resource amount log of individual usage. For example, 0 or a character string indicating total usage is assigned to the virtual machine ID portion in the resource amount log of total usage and −1 or a character string indicating the remaining amount is assigned to the virtual machine ID portion in the resource amount log of the remaining amount so that each can be distinguished from the resource amount log of individual usage.

Hereinafter, unless otherwise specified, the three types of resource amount log of individual usage, resource amount log of total usage, and resource amount log of the remaining amount are collectively referred to as the resource amount log, and the combination of the area ID, the building ID, the server ID, and the virtual machine ID are referred to as the resource position ID. The resource position ID becomes a unique value under the ICT instrument monitoring device 20.

### (Operation Example)

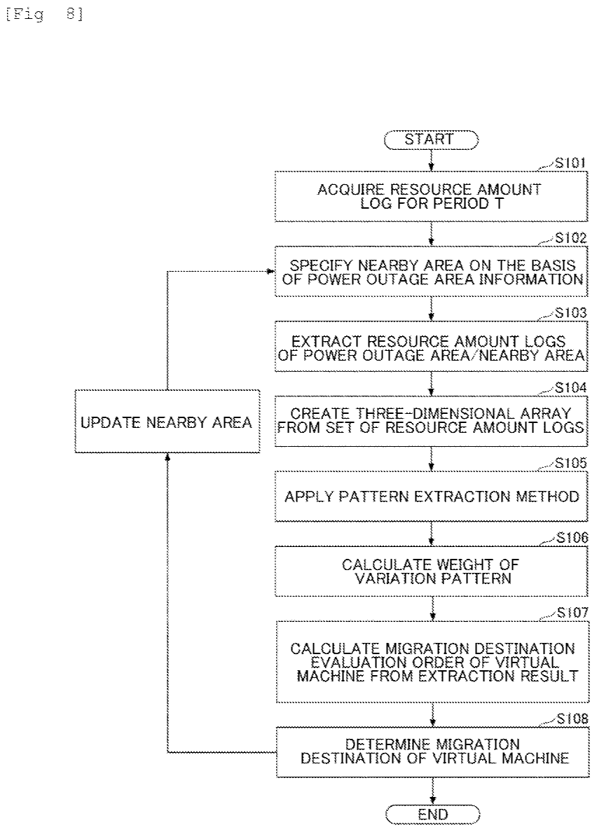

Hereinafter, an operation example of the ICT resource migration destination determination apparatus 100 will be described. FIG. 8 is a flowchart illustrating an example of a processing procedure executed by the ICT resource migration destination determination apparatus 100. The processing procedure will be described according to the procedure of the flowchart of FIG. 8. Meanwhile, a series of processing procedures to be described with reference to FIG. 8 can be implemented in any program language, script language, or a combination thereof.

### <S101 to S104>

The preprocessing unit 110 reads out the resource amount log recorded in the ICT instrument monitoring device 20, and narrows down and processes data necessary for analysis through processing to be described later. One three-dimensional array X is obtained as an output result of the preprocessing unit 110. The detailed procedure is as follows.

First, in S101, the preprocessing unit 110 acquires a set of resource amount logs (three types of resource amount logs) for a period T determined in advance from the ICT instrument monitoring device 20 with reference to the time stamp. The start time t1 and end time t2 of the period T are numerical values arbitrarily determined by the person performing the analysis, but it is preferable to target several days' worth of logs in order to see the trend in resource fluctuations. In addition, it is assumed that each resource value in the resource amount log is discretized with a time granularity of, for example, 1 minute or 5 minutes on the basis of the aggregation specifications of the ICT instrument monitoring device 20.

Next, in S102 and S103, the preprocessing unit 110 extracts the resource amount log of individual usage associated with the physical server located in the power outage area, from the resource amount log acquired in S101, on the basis of power outage area information separately designated by the person performing the analysis. At the same time, the resource amount log of total usage and the resource amount log of the remaining amount associated with the physical server located in the nearby area up to a distance d from the power outage area are extracted.

Here, in S102, the preprocessing unit 110 specifies a nearby area at the distance d from the power outage area, as follows, on the basis of the adjacent area list defined in advance by the person performing the analysis.

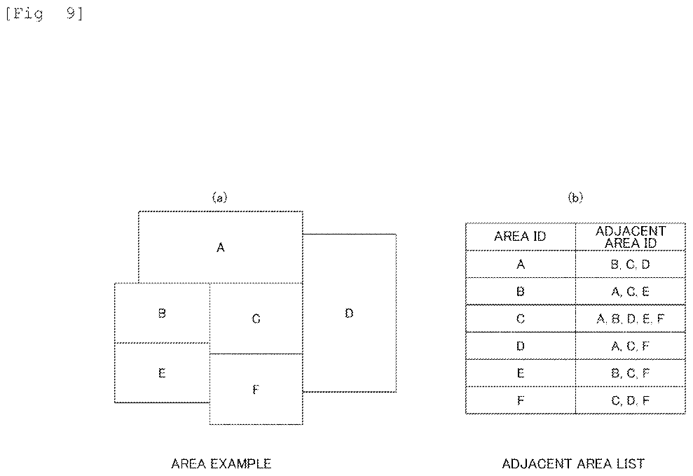

Now, when focusing on a specific area (for example, area A in FIG. 9(a)), the area A and areas (A, B, C, D) adjacent to the area A are nearby areas at a distance 1 from the area A. Next, areas (A, B, C, D, E, F) including nearby areas at a distance 1 from the area A and areas adjacent thereto are nearby areas at a distance 2 from the area A. By tracing the adjacent area list (FIG. 9(b)) in this way, a nearby area at a distance d (d is an integer) from the designated area is specified.

Further, in S104, the preprocessing unit 110 generates a three-dimensional array X representing the relationship between the resource position ID, the resource item, and the time stamp from a set of extracted resource amount logs. The three-dimensional array X is data having position ID, each resource item name, and each time stamp as an item of each axis, and having the resource values as elements. Meanwhile, data of multiple time stamps may be converted to a larger time granularity such as 30 minutes or one hour, and the resource value may be a statistical value for the time interval in the relevant time granularity. At this time, as a method of calculating the statistical value, an average value, a maximum value, a median value, and the like are assumed.

Any one of these statistical values may be used, or a plurality of values may be used in the form of the interval average value of the resource item, the interval maximum value of the resource item, and the interval median value of the resource item. This is to adjust the degree to which the physical resource upper limit amount is allowed to be exceeded during migration, taking into account that the effect of exceeding the physical resource upper limit amount differs depending on the difference in the resource item. For example, in a case where the resource item to be handled is power, exceeding the physical resource upper limit amount causes the breaker to cut off supply of power to the physical server, and thus the maximum value is required to be used as a statistic. Meanwhile, in a case where the resource item to be handled is a virtual CPU or line bandwidth, the effect is limited only to the occurrence of waiting time for processing or transfer even when the physical resource upper limit amount is temporarily exceeded, and thus the average value or the median value may be used as a statistic.

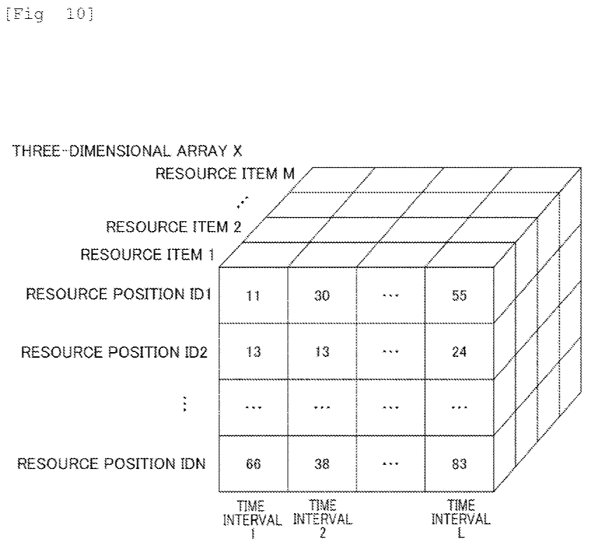

FIG. 10 shows an example of a three-dimensional array X. In FIG. 10, the time interval, the resource item name, and the resource position ID are set as items of the respective axes. The number of items L on the time interval axis is a number depending on the period T of the input observation information and the aggregation granularity. The number of items M on the resource item axis is a number depending on the resource items collected by the ICT instrument monitoring device 20. The number of items N of the resource position ID is a number depending on the physical server/virtual machine existing in a nearby area at the distance d selected by the preprocessing unit 110. Elements of a three-dimensional array X corresponding to a certain time interval 1∈L, a certain resource item m∈M, and a certain resource position ID n∈N are represented by x_{1, m, n}. The three-dimensional array X created in S104 is stored in a storage means such as a memory in the ICT resource migration destination determination apparatus 100 and is read out in subsequent processing.

### <S105>

In S105, the extraction unit 120 receives the three-dimensional array X processed in the preprocessing unit 110 as an input, extracts any predetermined number K of representative ICT resource load variation patterns from the input data by applying a pattern extraction method to be described later, and calculates “the degree of association” indicating the degree to which the items of the respective axes of the input data are associated with each pattern. Three two-dimensional arrays A, B, and C and one three-dimensional array H are obtained as the output results of the extraction unit 120.

Here, the obtained two-dimensional array has, as elements, the degree of association between the items of the respective axes of the three-dimensional array X and predetermined K representative ICT resource load variation patterns using a pattern extraction method to be described later.

Among the obtained two-dimensional arrays, a two-dimensional array with time stamps (or time intervals) and representative ICT resource load variation patterns as axes is hereinafter defined as A, a two-dimensional array with resource item names and representative ICT resource load variation patterns as axes is hereinafter defined as B, and a two-dimensional array with resource position IDs and representative ICT resource load variation patterns as axes is hereinafter defined as C.

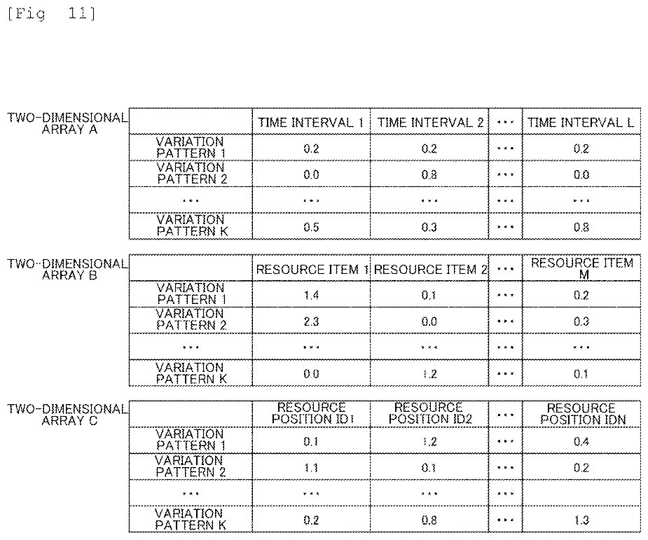

FIG. 11 shows an example of two-dimensional arrays A, B, and C, which are output results of the pattern extraction method. As shown in FIG. 11, K time-series variations can be obtained from the two-dimensional array A.

In addition, from the two-dimensional array B, it is possible to ascertain the resource item name that is a basis for extracting each representative ICT resource load variation pattern. That is, a resource item having a high degree of association with a certain variation pattern is considered to be a basis for extracting the variation pattern.

In addition, from the two-dimensional array C, it is possible to ascertain the resource position ID that is a basis for extracting each representative ICT resource load variation pattern. Note that, the three-dimensional array H is data for calculating a three-dimensional array from three two-dimensional arrays.

Next, examples of pattern extraction methods applied by the extraction unit 120 will be described. As a pattern extraction method, any method for extracting the relationship between each axis and each pattern using a three-dimensional array as an input, such as non-negative tensor factorization (NTF), CP decomposition, or Tucker decomposition can be used.

For NTF, for example, “Max Welling, and Markus Weber. “Positive tensor factorization.” Pattern Recognition Letters 22.12, 1255-1261 (2001).” and the like can be used. In addition, for CP decomposition, “Carroll, J. D., Chang, J. “Analysis of individual differences in multidimensional scaling via an n-way generalization of “Eckart-Young“decomposition.” Psychometrika 35, 283-319 (1970).” and the like can be used. For Tucker decomposition, “Tucker, L. R. “Some mathematical notes on three-mode factor analysis.” Psychometrika 31, 279-311 (1966).” and the like can be used.

### <S106>

In S106, the priority calculation unit 130 calculates the weight of the variation pattern used to determine the order of evaluating the migration destination of the virtual machines (the order of the virtual machines) in the power outage area in accordance with the priority order for each resource item separately designated by the person performing the analysis. Regarding the priority order, for example, information indicating the priority order for each resource item is transmitted in advance from the terminal of the person performing the analysis to the ICT resource migration destination determination apparatus 100, and the ICT resource migration destination determination apparatus 100 holds the information indicating the priority order in a memory or the like. In S106, the ICT resource migration destination determination apparatus 100 performs the calculation using the information indicating the priority order.

The priority order can be arbitrarily specified by the person performing the analysis. For example, it can be considered that a highest priority is given to a memory/storage in which exclusive resource allocation is required, a high priority is given to power in which physical resource excess is not tolerated but some degree of temporal fluctuation in resource usage occurs, a medium priority is given to a CPU/bandwidth in which when physical resources are exceeded for a short time, the performance degradation is only temporary, a low priority is given to other items in which data is collected as the resource items but the influence on performance when physical resources are exceeded is unclear, and the like.

More specifically, the person performing the analysis sets a coefficient wₘ corresponding to the degree of priority in the priority order as information indicating the priority order. The coefficient assigns a larger value to a resource item with a higher priority order (w₁≥w₂≥ . . . wₘ≥0). The priority calculation unit 130 calculates the weight for the variation pattern k on the basis of this coefficient wₘ and the two-dimensional array B. Specifically, when the value of the degree of association between the variation pattern k and the resource item m in the two-dimensional array B is b_{k, m}, the following relation is the weight of the variation pattern k.

Σ_{m∈{1, . . . ,M}}wₘb_{k,m}

This value represents the degree of association between the variation pattern k and the resource item with a high priority.

### <S107, S108>

In S107 and S108, the migration destination determination unit 140 determines the migration destination of each virtual machine in the power outage area on the basis of the weight for each variation pattern calculated by the priority calculation unit 130 and the two-dimensional array C. The migration destination determination unit 140 transmits the determined migration destination to the control device 30.

First, in S107, the migration destination determination unit 140 divides the two-dimensional array C into three partial arrays on the basis of information on the resource position ID. That is, there are three partial arrays: a partial array associated with the resource position ID set of the virtual machine in the power outage area, a partial array associated with the resource position ID set of the physical server in the nearby area, and each partial array related to the total resource usage and the remaining resource amount of the physical server.

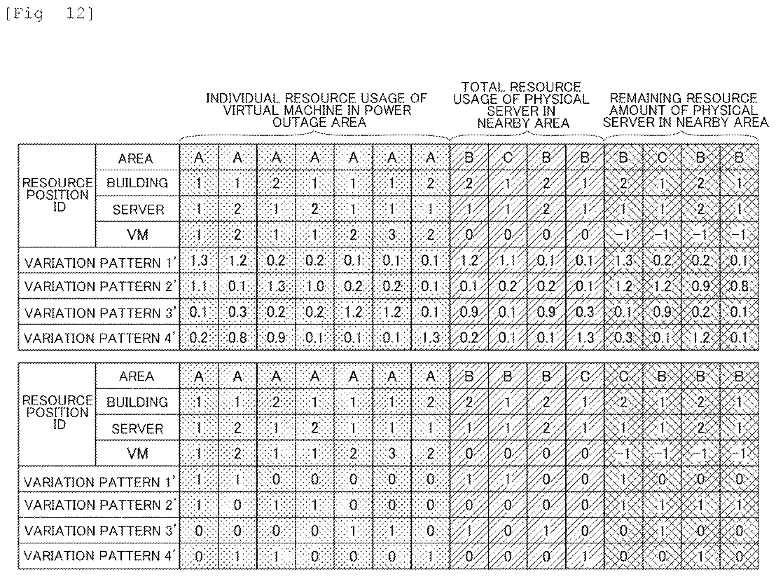

FIG. 12 shows a simple example of three partial arrays. In FIG. 12, in order to make the description easier to understand, the variation pattern axis of the two-dimensional array C is sorted in descending order of weight (Σ_{m∈{1, . . . , M}}wₘb_{k, m}), and the resource position ID axis is sorted in descending order of the degree of association with each variation pattern. Here, first, the resource position ID axis is sorted in descending order of the degree of association in the first (largest weight) variation pattern, and the resource position ID axis with the same degree of association is sorted in descending order of the degree of association in the next largest weight variation pattern. In this way, the resource position ID axis is sorted in descending order of the degree of association with each variation pattern.

In addition, the resource position IDs are an area ID, a building ID, a server ID, a virtual machine ID, and values of 0 and −1. In this example, a power outage occurs in the area A, and the migration destination of the virtual machine is evaluated using the nearby areas B and C as candidates.

Hereinafter, for convenience of description, a new order index is assigned to each. That is, the relation of nᵤ={1, . . . , Nᵤ} is established in descending order of the degree of association with each variation pattern for the individual resource usage of the virtual machine in the power outage area, the relation of nₜ={1, . . . , Nₜ} is established in descending order of the degree of association with each variation pattern for the total resource usage of the physical server in the nearby area, and the relation of nᵣ={1, . . . , Nᵣ} is established in descending order of the degree of association with each variation pattern for the remaining resource amount of the physical server in the nearby area. Meanwhile, the relations of Nᵤ+Nₜ+Nᵣ=N and Nₜ=Nᵣ are established.

The relation of nᵤ={1, . . . , Nᵤ} indicates the migration destination evaluation order of the virtual machines. For example, in the example of FIG. 11, the virtual machine with the resource position ID={A, 1, 1, 1} is nᵤ=1, and the virtual machine with the resource position ID={A, 1, 2, 2} is nᵤ=2, . . . .

In addition, in order to simplify the determination, the values of the two-dimensional array are converted to 0 and 1 by a threshold determined separately (the converted values are shown below in FIG. 11). This threshold may be arbitrarily set by the person performing the analysis, or may be set to the average value or the median value of the values in the two-dimensional array C. Hereinafter, processing is performed using the three converted partial arrays.

Values (values of elements in the partial array) corresponding to the variation pattern k and order indexes nᵤ, nₜ, and nᵣ in the two-dimensional array C are defined as c_{k, n_u}, c_{k, n_t} and c_{k, n_r}, respectively. In S108, the migration destination determination unit 140 determines the physical server of the migration destination for the virtual machine nᵤ in the power outage area according to the next procedure.

The migration destination determination unit 140 evaluates the following (1), (2), (3-1), and (3-2) for the virtual machine nᵤ={1, . . . , Nᵤ} in this order.

(1) Evaluate the following Expression 1 for the physical server nᵣ={1, . . . , Nᵣ} in this order in the nearby area that is a migration destination candidate.

$${min}_{k} ( {c}_{k , n \_ r} - {c}_{k , n \_ u} ) \geq 0 \qquad Expression 1$$

Meanwhile, minₖ(c_{k, n_r}−c_{k, n_u}) represents the minimum “c_{k, n_r}−c_{k, n_u}” among “c_{k, n_r}−c_{k, n_u}” for k=1 to K. The same is true for the following expression using min.

The establishment of Expression 1 means that “c_{k, n_r}=0, c_{k, n_u}=1” does not hold for any k. “c_{k, n_r}=0, c_{k, n_u}=1” indicates that the remaining resource amount of the physical server nᵣ has a low degree of association with the variation pattern having a high degree of association with the resource usage of the virtual machine nᵤ. In this case, there is a possibility of a high degree of similarity between the variation pattern in the resource usage of the virtual machine nᵤ and the variation pattern in the resource usage of the physical server nᵣ.

That is, Expression 1 means selecting a physical server nᵣ such that the similarity in the variation pattern in resource usage between the virtual machine nᵤ and the physical server nᵣ is low.

For one or more physical servers nᵣ for which Expression 1 is established, the following expression is evaluated for all resource items m with the physical server nᵣ as a migration destination candidate for the virtual machine nᵤ.

$${min}_{1} ( {x}_{1 , m , n \_ r} - {x}_{1 , m , n \_ u} ) \geq - {δ}_{m} \qquad Expression 2$$

The establishment of Expression 2 indicates that for all time intervals, the excess amount of the resource usage of the virtual machine nᵤ over the remaining resource amount of the physical server nᵣ is equal to or less than δₘ with respect to the resource item m.

In a case where Expression 2 is established for all resource items m, the physical server nᵣ is determined as a migration destination server n*ᵤ of the virtual machine nᵤ. Here, δₘ is the excess allowable amount that is set for the resource item, and may be separately designated by the person performing the analysis, or may be given as “δₘ=Rₘ^{max}/wₘ” using the coefficient wₘ corresponding to the degree of priority in the priority order. That is, the higher the priority, the smaller the excess allowable amount, so that a physical server with a larger remaining amount can be selected for the resource item. Here, Rₘ^{max} represents the upper limit in the resource item m.

(2) In a case where the migration destination of the virtual machine nᵤ is not determined in the processing of (1), the following Expression 3 is evaluated for the physical servers nₜ={Nₜ, . . . , 1} in this order (in descending order of the degree of association with the variation pattern) in the nearby area that are migration destination candidates.

$${max}_{k} ( {c}_{k , n \_ t} + {c}_{k , n \_ u} ) \leq 1 \qquad Expression 3$$

Meanwhile, maxₖ(c_{k, n_t}+c_{k, n_u}) represents the maximum “c_{k, n_t}+c_{k, n_u}” among “c_{k, n_t}+c_{k, n_u}” for k=1 to K. The same is true for the following expression using max.

The establishment of Expression 3 indicates that c_{k, n_t} and c_{k, n_u} do not become 1 at the same time, and thus indicates that the similarity in the variation pattern in resource usage between the virtual machine nᵤ and the physical server nₜ is low.

In a case where Expression 3 is established, the following Expression 4 is evaluated for all resource items m with respect to the remaining amount nᵣ corresponding to the physical server nₜ with the physical server nₜ as a migration destination candidate for the virtual machine nᵤ.

$${max}_{1} ( {x}_{1 , m , n \_ u} ) \leq {x}_{1 , m , n \_ r} + {δ}_{m} \qquad Expression 4$$

The establishment of Expression 4 indicates that for all time intervals, the resource usage of the virtual machine nᵤ is equal to or less than the sum of the remaining resource amount and the excess allowable amount of the physical server nₜ with respect to the resource item m.

In a case where Expression 4 is established for all resource items m, the physical server nₜ is determined as a migration destination server n*ᵤ of the virtual machine nᵤ.

(3-1) In a case where the migration destination of the virtual machine nᵤ is determined in the processing of the above (1) or (2), the total usage (x_{n_t, m, l}) and the remaining amount (x_{n_r, m, l}) of the physical server are update as follows on the basis of the area ID, the building ID, and the server ID of the migration destination server n′ᵤ.

The relations are established for all m and l:

$${x}_{1 , m , n \_ t} ← {x}_{1 , m , n \_ t} + {x}_{1 , m , n \_u} ,$$

$${x}_{1 , m , n \_ r} ← {x}_{1 , m , n \_ r} - {x}_{1 , m , n \_u}$$

Here, in a case where the relation of minₗ(x_{l, m, n_r})≤δₘ is established for all m and l, the physical server is excluded from the migration destination candidates in the subsequent processing.

(3-2) In a case where the migration destination of the virtual machine nᵤ is not determined in the processing of the above (1) and (2), the virtual machine nᵤ is added to a list of undetermined migration destination virtual machines, assuming that the virtual machine cannot be housed in the nearby area that is a migration destination candidate. Meanwhile, the list of undetermined migration destination virtual machines is stored in a storage unit such as a memory of the ICT resource migration destination determination apparatus 100.

The above is the processing of (1), (2), (3-1), and (3-2).

For the undetermined migration destination virtual machines described in the list of undetermined migration destination virtual machines, a series of processing is completed, and then the same processing is performed on servers existing in a nearby area at a distance d+1.

In addition, in a case where the migration destinations of virtual machines are desired to be consolidated in units of building units/servers, the above evaluation need only be performed by rounding in units of buildings or units of servers.

In order to start migration more quickly, it is preferable to perform the processing according to the present embodiment for each area during normal times and to calculate migration destination candidates for the virtual machines in each area.

### (Hardware Configuration Example)

The ICT resource migration destination determination apparatus 100, the ICT instrument monitoring device 20, the physical server 10 (ICT instrument, information communication device), the control device 30 can all be realized, for example, by causing a computer to execute a program. For the ICT resource migration destination determination apparatus 100, the ICT instrument monitoring device 20, and the control device 30, this computer may be a physical computer or a virtual machine. Hereinafter, the ICT resource migration destination determination apparatus 100, the ICT instrument monitoring device 20, the physical server 10, and the control device 30 are collectively referred to as the “device.”

That is, the device can be realized by executing a program corresponding to the processing performed by the device using hardware resources such as a CPU and a memory built into a computer. The above program can be stored or distributed with the program recorded on a computer readable recording medium (such as a portable memory). In addition, the above program can also be provided through a network such as the Internet or e-mail.

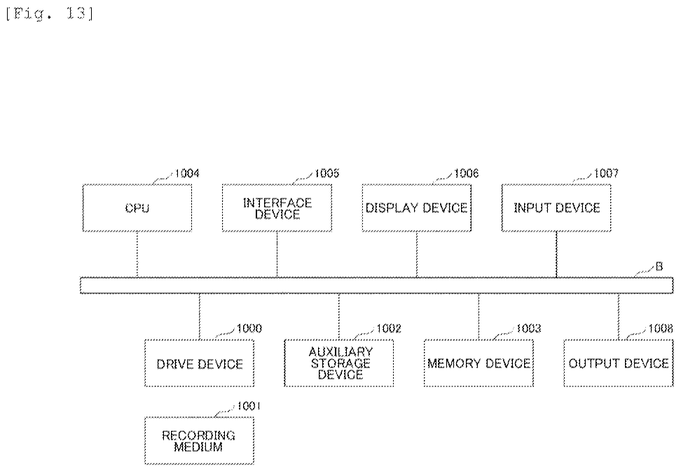

FIG. 13 is a diagram illustrating a hardware configuration example of the above computer. The computer of FIG. 13 has a drive device 1000, an auxiliary storage device 1002, a memory device 1003, a CPU 1004, an interface device 1005, a display device 1006, an input device 1007, an output device 1008, and the like that are connected to each other through a bus BS.

A program for realizing processing in the computer is provided by a recording medium 1001 such as, for example, a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, or the like.

In response to an activation instruction of a program, the memory device 1003 reads out the program from the auxiliary storage device 1002 and stores the program. The CPU 1004 realizes a function relevant to the device in accordance with the program stored in the memory device 1003. The interface device 1005 is used as an interface for connection to a network or the like. The display device 1006 displays a graphical user interface (GUI) or the like based on the program. The input device 1007 is constituted by a keyboard, a mouse, a button, a touch panel, or the like, and is used for inputting various operation instructions. The output device 1008 outputs arithmetic results.

### Effects of Embodiment

With the technique according to the present embodiment, the migration destination can be determined based on the similarity between the load status of the virtual machine in the power outage area and the load status of the physical server in the nearby area, and thus it is possible to realize migration with reduced conflict of resource variation associated with load superposition.

### Conclusion of Embodiment

The present specification discloses at least a migration destination determination apparatus, a physical server, a migration destination determination system, a migration destination determination method, and a program according to the following items.

### (Paragraph 1)

A migration destination determination apparatus configured to, in migration of a virtual machine, determine a physical server as a migration destination of the virtual machine, the migration destination determination apparatus including:
an extraction unit configured to extract one or more variation patterns in resource usage from resource amount logs acquired from a plurality of physical servers; and
a migration destination determination unit configured to determine, based on a similarity between a variation pattern in resource usage of the virtual machine in an area of a migration source and a variation pattern in resource usage of a physical server in another area, the physical server as a migration destination of the virtual machine.

### (Paragraph 2)

The migration destination determination apparatus according to paragraph 1, wherein
the extraction unit is configured to generate, from the resource amount logs, a three-dimensional array having a time interval axis, a resource position axis, and a resource item axis, with resource values as elements, and to calculate a degree of association indicating a degree to which items of respective axes and each of the variation patterns are associated with each other from the three-dimensional array, and
the migration destination determination unit is configured to determine the similarity using the degree of association.

### (Paragraph 3)

The migration destination determination apparatus according to paragraph 2, wherein, in a case where a similarity of variation patterns between the virtual machine and a physical server is determined to be low based on the degree of association between the virtual machine and each of the variation patterns and the degree of association between the physical server and each of the variation patterns, the migration destination determination unit is configured to determine the physical server as one of migration destination candidates.

### (Paragraph 4)

The migration destination determination apparatus according to paragraph 3, wherein the migration destination determination unit is configured to determine a physical server as the migration destination from one or more physical servers of the migration destination candidates based on a remaining resource amount in the physical servers of the migration destination candidates and the resource usage of the virtual machine.

### (Paragraph 5)

A migration destination determination system including:
the migration destination determination apparatus according to any one of paragraphs 1 to 4; and
an ICT instrument monitoring device configured to collect the resource amount logs from the plurality of physical servers.

### (Paragraph 6)

A physical server from which a resource amount log used in the migration destination determination apparatus according to any one of paragraphs 1 to 4 is acquired, the physical server including:
a migration execution unit configured to receive information on the migration destination of the virtual machine determined by the migration destination determination apparatus and migrate the virtual machine to the migration destination.

### (Paragraph 7)

A migration destination determination method executed by a migration destination determination apparatus configured to, in migration of a virtual machine, determine a physical server as a migration destination of the virtual machine, the migration destination determination method including:
an extraction step of extracting one or more variation patterns in resource usage from resource amount logs acquired from a plurality of physical servers; and
a migration destination determination step of determining, based on a similarity between a variation pattern in resource usage of the virtual machine in an area of a migration source and a variation pattern in resource usage of a physical server in another area, the physical server as a migration destination of the virtual machine.

### (Paragraph 8)

A program for causing a computer to function as the migration destination determination apparatus according to any one of paragraphs 1 to 4.

Hereinbefore, although the present embodiment has been described, the present invention is not limited to such a specific embodiment, and can be modified and changed variously without departing from the scope of the invention described in the appended claims.

### REFERENCE SIGNS LIST

10 Physical server
11 Virtual machine
12 Migration execution unit
20 ICT instrument monitoring device
30 Control device
100 ICT resource migration destination determination apparatus
110 Preprocessing unit
120 Extraction unit
130 Priority calculation unit
140 Migration destination determination unit
1000 Drive device
1001 Recording medium
1002 Auxiliary storage device
1003 Memory device
1004 CPU
1005 Interface device
1006 Display device
1007 Input device
1008 Output device

1. A migration destination determination apparatus configured to determine a physical server as a migration destination of a virtual machine, the migration destination determination apparatus comprising:
a memory; and
a processor coupled to the memory and configured to:
determine, based on a similarity between a variation pattern in resource usage of the virtual machine in an area of a migration source and a variation pattern in resource usage of a physical server in another area, the physical server as a migration destination of the virtual machine; and
calculate, using a resource value associated with information identifying at least one of the virtual machine and the physical server in a predetermined time interval, a degree of association indicating a degree to which the information and the variation pattern in the resource usage of the at least one of the virtual machine and the physical server are associated with each other,
wherein the processor is configured to determine the similarity using the degree of association.

2. The migration destination determination apparatus according to claim 1, wherein
the processor is configured to extract one or more variation patterns in resource usage from resource amount logs acquired from a plurality of physical servers, and
the processor is configured to generate, from the resource amount logs, a three-dimensional array having a time interval axis, a resource position axis, and a resource item axis, with resource values as elements, and to calculate a degree of association indicating a degree to which items of respective axes and each of the variation patterns are associated with each other from the three-dimensional array.

3. The migration destination determination apparatus according to claim 2, wherein, in a case where a similarity of variation patterns between the virtual machine and a physical server is determined to be low based on the degree of association between the virtual machine and each of the variation patterns and the degree of association between the physical server and each of the variation patterns, the processor is configured to determine the physical server as one of migration destination candidates.

4. The migration destination determination apparatus according to claim 3, wherein the processor is configured to determine a physical server as the migration destination from one or more physical servers of the migration destination candidates based on a remaining resource amount in the physical servers of the migration destination candidates and the resource usage of the virtual machine.

5. A migration destination determination system comprising:
the migration destination determination apparatus according to claim 1; and
an information and communication technology (ICT) instrument monitoring device configured to collect information on the resource usage from the physical server.

6. A physical server from which information on the resource usage used in the migration destination determination apparatus according to claim 1 is acquired, the physical server comprising:
a memory; and
a processor coupled to the memory and configured to:
receive information on the migration destination of the virtual machine determined by the migration destination determination apparatus and migrate the virtual machine to the migration destination.

7. A migration destination determination method executed by a migration destination determination apparatus configured to determine a physical server as a migration destination of a virtual machine, the migration destination determination method comprising:
determining, based on a similarity between a variation pattern in resource usage of the virtual machine in an area of a migration source and a variation pattern in resource usage of a physical server in another area, the physical server as a migration destination of the virtual machine and
calculating, using a resource value associated with information identifying at least one of the virtual machine and the physical server in a predetermined time interval, a degree of association indicating a degree to which the information and the variation pattern in the resource usage of the at least one of the virtual machine and the physical server are associated with each other,
wherein in the determining of the physical server, the similarity is determined using the degree of association.

8. A non-transitory computer-readable recording medium storing a program for causing a computer to perform the method of claim 7.
